(19) United States
(12) Patent Application Publication
(10) Pub. No.: US 2016/0010296 A1
(43) Pub. Date: Jan. 14, 2016

(54) PINNIPEDS DOCK DETERRENT SYSTEM

(71) Applicant: PAUL R. GERST, NEWPORT BEACH, CA (US)

(72) Inventor: PAUL R. GERST, NEWPORT BEACH, CA (US)

(21) Appl. No.: 14/793,998

(22) Filed: Jul. 8, 2015

Related U.S. Application Data
(60) Provisional application No. 62/022,312, filed on Jul. 9, 2014.

(51) Int. Cl. E02B 1/00; A01K 61/00

(52) U.S. Cl. CPC E02B 1/006; A01K 61/00

(57) ABSTRACT

A barrier system for a floating dock to inhibit marine life from jumping or climbing onto the upper surface of the dock. According to one embodiment, the barrier system includes a support frame which is secured to the dock. One or more rollers are coupled to the support frame in a manner which allows the rollers to roll or rotate relative to the support frame. The barrier system further includes one or more electrical wires which provide low voltage pulses therethrough.

### CROSS-REFERENCE TO RELATED APPLICATIONS

This application claims the benefit of U.S. Provisional Application Ser. No. 62/022,312, filed Jul. 9, 2014, the contents of which are expressly incorporated herein by reference.

### STATEMENT RE: FEDERALLY SPONSORED RESEARCH/DEVELOPMENT

Not Applicable

### BACKGROUND OF THE INVENTION

The present invention relates generally to a barrier for a floating dock, and more specifically, to a barrier connected to a floating dock to inhibit marine life from jumping out of the water and onto the surface of the floating dock.

Floating docks are well known in the art and are utilized primarily along ocean coastlines to accommodate the fluctuating water levels associated with environmental conditions such as rainfall and/or the changing tides. Since the dock is floating, the upper walking surface of the dock is not far above the waterline. Therefore, it is easy for marine life, particularly pinnipeds such as seals or sea lions, to jump or climb out of the water and onto the dock.

The presence of seals, sea lions, or the like on a floating dock may be highly undesirable as such marine life may create a safety and/or walking hazard for those walking on the dock, particularly at night, when such marine life may not be easily seen. The marine life may also create unsanitary conditions if they remain on the dock for extended periods of time, as waste and odors from the marine life may accumulate on the dock.

Therefore, there is a significant need in the art for a system which inhibits marine life from jumping out of the water and onto a floating dock. Various aspects of the present invention address this particular need, as described in more detail below.

### BRIEF SUMMARY OF THE INVENTION

Various aspects of the present invention are directed toward providing a barrier system for a floating dock to inhibit marine life from jumping or climbing onto the upper surface of the dock. According to one embodiment, the barrier system includes a support frame which is secured to the dock. One or more rollers are coupled to the support frame in a manner which allows the rollers to roll or rotate relative to the support frame, thereby inhibiting the marine life from climbing onto the dock. The barrier system may further include one or more electrical wires which provide low voltage pulses therethrough which provides an additional deterrent to the marine animals.

The barrier system may be configured and adapted to make it extremely difficult for marine life to jump out of the water and onto the surface of the dock. The rollers are designed to prevent marine life from grabbing onto a surface for pulling itself out of the water. Rather, if a marine animal attempts to grab onto the roller, the animal simply rolls back, safely, into the water. Furthermore, if the marine animal touches the electrical wire, the barrier system may impart a low voltage shock, in which case, they are discouraged from repeatedly attempting to climb onto the dock.

The barrier system may also include an acoustic transducer which emits acoustic signals into the water which discourage the seals from approaching the dock and climbing or jumping onto the dock.

According to another embodiment, there is provided a barrier for use with a dock having a dock upper surface facing away from an underlying body of water to deter a marine animal from moving onto the dock. The barrier includes a frame adapted to be securable to the dock with the frame extending in an upward direction above the dock upper surface. An anti-grip barrier element is coupled to the frame and is configured to inhibit a marine animal from transferring a load onto the frame via the anti-grip barrier element so as to inhibit the marine animal from climbing onto the dock.

The anti-grip barrier may be coupled to the frame in a manner which allows the anti-grip barrier to roll over a portion of the frame.

The barrier may include an electronic barrier coupled to the frame and adapted to impart an electrical shock to the marine animal in response to the marine animal contacting the electronic barrier.

The barrier may further comprise an acoustic barrier coupled to the dock and adapted to emit an acoustic signal. The acoustic barrier may be adapted to be submersible in the body of water.

The frame may include a pair of spaced frame members extending above the dock upper surface, the barrier further comprising a face panel extending between the pair of spaced frame members.

The present invention will be best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a side sectional view of one embodiment of a barrier system coupled to a dock; and

FIG. 2 is a partial upper perspective view of the barrier system.

Common reference numerals are used throughout the drawings and a detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for purposes of illustrating a preferred embodiment of the present invention only, and not for purposes of limiting the same, there is depicted a barrier system 10 configured for use with a floating dock 12, wherein the barrier system 10 is specifically configured and adapted to inhibit marine life from jumping or climbing onto the dock 12. In particular, the barrier system 10 is designed to inhibit pinnipeds such as seals and the like from jumping or climbing onto the dock 12. As will be described in more detail below, the system 10 may include one or more barrier elements intended to prevent the pinnipeds from climbing onto the dock. The barrier element(s) may include a series of rollers which prevent the pinnipeds from reaching onto the dock and instead the roller will roll which causes the pinnipeds to fall back into the water. The barrier element(s) may additionally include an electrical wire or fence which imparts a low voltage shock to the pinniped to discourage the pinniped from making subsequent attempts to climb onto the dock 12.

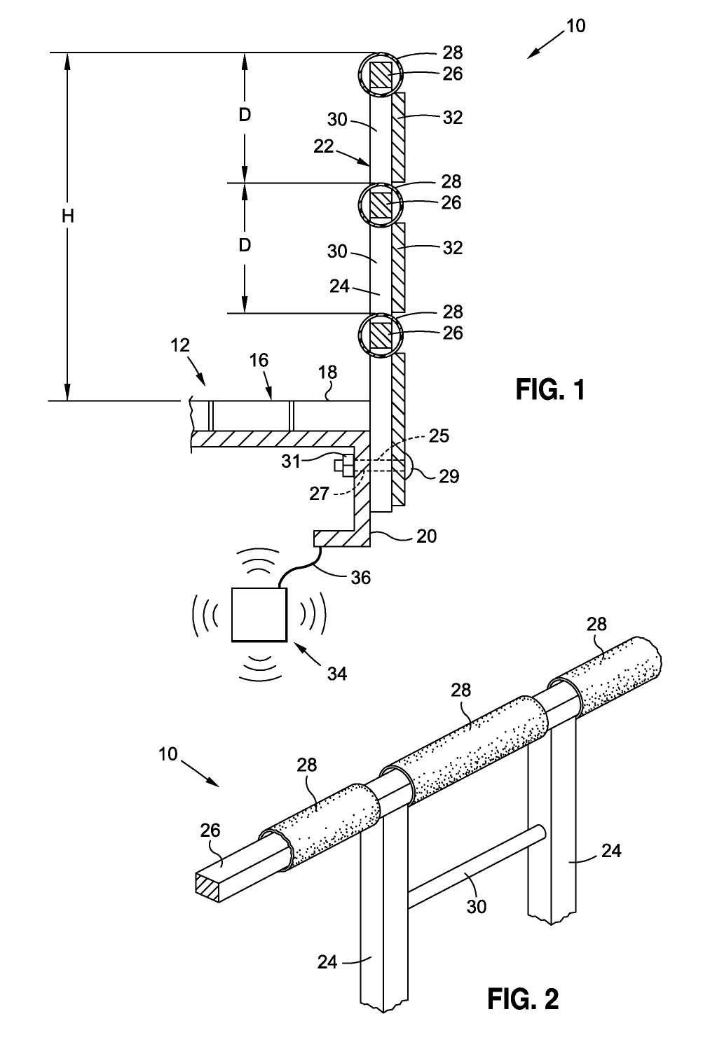

It is contemplated that the barrier system 10 may be used with a wide range of docks, including floating docks, conventional ground-supported docks, as well as being used on fixed piers, jetties, vessels, pedestrian areas adjacent to water, railings on shore, or anywhere a seal can jump from the water, etc. FIG. 1 is a side view of the barrier system 10 attached to a dock 12, wherein the dock 12 includes a dock frame 14 and an upper plank 16 having an upper walking surface 18 which faces away from the underlying body of water (now shown). The dock 12 includes an end wall 20 which may be used for attaching the barrier system 10 to the dock 12, as will be described in more detail below. In this respect, it is understood that the barrier system 10 may be coupled to the dock frame 14 and/or the upper plank 16. The dock frame 14 and dock plank 16 may be formed of various materials known in the art configured to withstand salt water. According to one embodiment, the dock frame 14 and dock plank 16 are formed from a pultruded material. For a more detailed discussion of a preferred dock 12, please refer to U.S. Pat. No. 8,402,908, entitled Dock System, the contents of which are expressly incorporated herein by reference.

The barrier system 10 includes a barrier frame 22 having vertical support members 24 and horizontal support members 26. The vertical support members 24 are fastened to the end wall 20 of the dock frame 14 via bolts, screws, clamps, rivets, adhesives or other fasteners known in the art. In the embodiment depicted in FIGS. 1 and 2, the vertical and horizontal support members 24, 26 are formed from hollow tubing, wherein the vertical support members 24 include an support member aperture 25 aligned with a dock aperture 27 to accommodate the passage of a bolt 29 which is secured via a nut 31. However, those skilled in the art would readily appreciate that tubing having different shapes and configurations may also be used without departing from the spirit and scope of the present invention. The vertical and horizontal support members 24, 26 are preferably elongate, rigid members formed from a weather-resistant (e.g., salt-water resistant, UV resistant) material, such as a pultruded material, metal material, or wood, although other materials known in the art may also be used.

The horizontal support members 26 may extend between adjacent ones of the vertical support members 24. The horizontal support members 26 may be coupled to the vertical support members via welding, mechanical fasteners, adhesives or other coupling techniques known by those skilled in the art.

A series of rollers 28 are rotatably coupled to the barrier frame 22, specifically the rollers 28 shown in FIGS. 1 and 2 are coupled to the horizontal support members 26 and are located between adjacent vertical support members 24. The rollers 28 are formed from a hollow tube, such as a hollow metal tube, which may be coated with a rubber or foam material. The external surface of the rollers 28 may formed with an anti-grip (e.g., smooth) coating to inhibit the ability of a marine animal to grab on to the roller 28. According to one embodiment, each roller 28 may simply roll around a respective one of the horizontal support members 26 by virtue of the hollow configuration of the roller 28. In this respect, it is contemplated that the horizontal support member 26 may also be formed in a cylindrical configuration to enhance the ability of the roller 28 to roll about the horizontal support member 26. Alternatively, it is understood that each roller 28 may be coupled to the barrier frame 22 via one or bearing assemblies which may allow for smoother rotation of the roller 28.

The barrier system 10 may extend upwardly from upper walking surface 18 of the dock 12 to provide several levels of rollers 28. The rollers 28 may be vertically separated such that the top of each roller 28 is separated from the top of an adjacent roller 28 by a distance D. Furthermore, the top of the uppermost roller 28 may be spaced from the upper walking surface 18 of the dock 12 by a height H. According to one embodiment, the distance D is equal to approximately ten inches, while the height H is equal to approximately twenty-four inches. Furthermore, although FIG. 1 shows three levels or rows of rollers 28, it is understood that other barrier systems may include less than three rows of rollers 28 or less than three rows of rollers 28. Moreover, although the exemplary embodiment shows rollers 28 only on the horizontal support members 26, it is also contemplated that rollers may also be fitted over the vertical support members 24.

The anti-grip barrier element may also include an electrical wire or fence 30, which may extend between adjacent vertical support members 24. The electrical wire 30 may carry low voltage DC pulses therethrough such that anything that contacts the wire 30 will receive an electrical shock. As such, should the marine animal receive an electrical shock, the animal would likely be deterred from attempting to climb onto the dock in the future. The electrical shock created by the wire 30 is similar to the shock imparted by a dog collar worn by a dog which passes through an invisible electric fence. The electrical wire 30 may be electrically coupled to a power source to receive electricity therefrom.

According to one embodiment, the barrier system 10 may include a safety module which controls the passage of current through the electrical wire 30. In this respect, the safety module may be adapted to detect marine animals attempting to climb/lunge out of the water and onto the dock 12 and pass and electrical current through the electrical wire 30 in response to such detection. If such a detection is not made, the safety module may be configured to restrict the flow of electrical current to prevent inadvertent electrical shock to anyone standing on the dock 12.

The barrier system 10 may optionally further include face panels 32 coupled to the vertical support members 24 to fill the area located between adjacent support members 24. The face panel 32 may be formed of plastic or other materials known in the art.

According to one embodiment, the barrier system 10 additionally includes a submerged or submersible acoustic transducer 34 configured to emit acoustic signals which discourage pinnipeds from approaching the dock 12. The acoustic transducer 34 may be tethered to the dock 12 by a tether 36, or alternatively, the acoustic transducer may be attached to the dock or anchored to the ocean floor.

In use, the barrier system 10 provides an effective deterrent for pinnipeds and other marine life from jumping or climbing out of the water and onto the upper surface of the dock 12. In particular, the rollers 28 prevent the pinnipeds from grabbing onto the dock 12 and pulling themselves up onto the dock 12. In this respect, should a pinniped attempt to grab onto the roller 28 for purposes of pulling itself out of the water, the roller 28 will rotate, and thus, the pinniped will not be able to transfer a load onto the roller 28, e.g., the roller 28 will not support the pinniped. Furthermore, should the pinniped extend out of the water and reach toward the barrier system 10 and contact the electrical wire 30, the electrical wire 30 provides a low voltage shock to discourage the pinnipeds from repeatedly attempting to climb onto the dock 12. The submerged acoustic transducer 34 also provides a deterrent by transmitting an electrical signal which alerts nearby pinnipeds to stay away from the dock 12. In this respect, the barrier system 10 provides a desirable solution to unwanted pinnipeds and marine life which may be present on the surface of the dock 12. As such, the walkways on the dock 12 remain safer and more sanitary than a dock having a pinniped or other marine life laying thereon.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A barrier for use with a dock having a dock upper surface facing away from an underlying body of water to deter a marine animal from moving onto the dock, the barrier comprising:
a frame adapted to be securable to the dock with the frame extending in an upward direction above the dock upper surface; and
an anti-grip barrier element coupled to the frame and configured to inhibit a marine animal from transferring a load onto the frame via the anti-grip barrier element so as to inhibit the marine animal from climbing onto the dock.

2. The barrier recited in claim 1, wherein the anti-grip barrier is coupled to the frame in a manner which allows the anti-grip barrier to roll over a portion of the frame.

3. The barrier recited in claim 1, wherein the anti-grip barrier includes a plurality of anti-grip barriers coupled to the frame in spaced relation to each other.

4. The barrier recited in claim 1, further comprising an electronic barrier coupled to the frame and adapted to impart an electrical shock to the marine animal in response to the marine animal contacting the electronic barrier.

5. The barrier recited in claim 4, further comprising an acoustic barrier coupled to the dock and adapted to emit an acoustic signal.

6. The barrier recited in claim 1, further comprising an acoustic barrier coupled to the dock and adapted to emit an acoustic signal.

7. The barrier recited in claim 6, wherein the acoustic barrier is adapted to be submersible in the body of water.

8. The barrier recited in claim 1, wherein the frame includes a pair of spaced frame members extending above the dock upper surface, the barrier further comprising a face panel extending between the pair of spaced frame members.

9. A barrier for use with a dock having a dock upper surface facing away from an underlying body of water to deter a marine animal from moving onto the dock, the barrier comprising:
a frame adapted to be securable to the dock with the frame extending in an upward direction above the dock upper surface; and
an electronic barrier coupled to the frame and adapted to impart an electrical shock to the marine animal in response to the marine animal contacting the electronic barrier so as to inhibit the marine animal from climbing onto the dock.

10. The barrier recited in claim 9, further comprising an acoustic barrier coupled to the dock and adapted to emit an acoustic signal.

11. The barrier recited in claim 10, wherein the acoustic barrier is adapted to be submersible in the body of water.

12. The barrier recited in claim 9, wherein the frame includes a pair of spaced frame members extending above the dock upper surface, the barrier further comprising a face panel extending between the pair of spaced frame members.

13. A dock adapted to deter a marine animal from moving onto the dock, the dock comprising:
a dock frame;
a barrier frame coupled to the dock frame with the barrier frame extending in an upward direction above the dock upper surface; and
an anti-grip barrier element coupled to the frame and configured to inhibit a marine animal from transferring a load onto the frame via the anti-grip barrier element so as to inhibit the marine animal from climbing onto the dock.

14. The barrier recited in claim 13, wherein the anti-grip barrier is coupled to the barrier frame in a manner which allows the anti-grip barrier to roll over a portion of the frame.

15. The barrier recited in claim 13, wherein the anti-grip barrier includes a plurality of anti-grip barriers coupled to the frame in spaced relation to each other.

16. The barrier recited in claim 13, further comprising an electronic barrier coupled to the barrier frame and adapted to impart an electrical shock to the marine animal in response to the marine animal contacting the electronic barrier.

17. The barrier recited in claim 16, further comprising an acoustic barrier coupled to the dock frame and adapted to emit an acoustic signal.

18. The barrier recited in claim 13, further comprising an acoustic barrier coupled to the dock frame and adapted to emit an acoustic signal.

19. The barrier recited in claim 18, wherein the acoustic barrier is adapted to be submersible in the body of water.

20. The barrier recited in claim 13, wherein the frame includes a pair of spaced frame members extending above a dock upper surface, the barrier further comprising a face panel extending between the pair of spaced frame members.
